(19) United States
(12) Patent Application Publication
(10) Pub. No.: US 2018/0224050 A1
(43) Pub. Date: Aug. 9, 2018

(54) Deposition device for well construction

(71) Applicant: Oleg Tumarkin, Myrtle Beach, SC (US)

(72) Inventor: Oleg Tumarkin, Myrtle Beach, SC (US)

(21) Appl. No.: 15/732,191

(22) Filed: Sep. 28, 2017

Related U.S. Application Data
(60) Provisional application No. 62/499,858, filed on Feb. 3, 2017.

(51) Int. Cl. F16L 58/10; E21B 27/04; E21B 41/00

(52) U.S. Cl. CPC F16L 58/1027; E21B 41/0078; E21B 27/04

(57) ABSTRACT

A well surfacing device, comprising: a surfacing head, including an inlet for deposition material disposed in a substantially vertical orientation and an outlet for deposition material disposed in a substantially horizontal orientation to a target surface; and a material feeding portion connected to the surfacing head, the material feeding portion delivering deposition material from above the head in a substantially vertical orientation downward to the surfacing head.

### FIELD OF THE INVENTION

The present invention relates broadly to well construction and maintenance, and more specifically to surfacing the inner surface of a well bore.

### BACKGROUND OF THE INVENTION

In the oil industry, well construction currently represents about 30% of all costs associated with an oil well. Operation, repair, and servicing represent the remaining 70%. Oil wells are typically drilled and casing or pipe segments are sunk into the well once the drill bit removes soil and rock and forms the bored aperture that is the well. Well pipe is usually made of steel, and delivered to the well site on trucks. During the construction of the well, the segments of pipe are placed down the hole and provide a smooth surface through which oil is removed to separate the oil from liquids in other geological layers and to separate layers with incompatible drilling requirements from each other. In the process of drilling, multiple layers of pipe have to be installed and cemented in place to prevent complications that would occur if drilling was done all at once. The weight of the pipe that needs to be installed is one of the main considerations in selecting the type of drilling equipment. With additional weight, the drilling rig becomes more expensive harder to service and to move. Over time, the pipe degrades and decays; cracks appear in the surface of the pipe, requiring removal and replacement, which is a labor-intensive, expensive project.

### SUMMARY OF THE INVENTION

In one aspect, the present invention provides a well surfacing device, comprising: a surfacing head, including an inlet for deposition material disposed in a substantially vertical orientation and an outlet for deposition material disposed in a substantially horizontal orientation to a target surface; and a material feeding portion connected to the surfacing head, the material feeding portion delivering deposition material from above the head in a substantially vertical orientation downward to the surfacing head.

In an embodiment, the material feeding portion comprises an Archimedes screw.

In an embodiment, the outlet for deposition material comprises an applicator nozzle, or plurality of nozzles. In an embodiment, the surfacing head comprises a plurality of blades.

In an embodiment, the blades in the plurality define apertures in which the deposited material is applied to a target surface.

In an embodiment, a sensor located on the surfacing head.

In an embodiment, the surfacing head comprises a vacuum.

In an embodiment, the surfacing head includes compressed air delivered from above ground.

In an embodiment, the target surface comprises segments of pipe.

In an embodiment, the target surface comprises a well bore.

In another aspect, the present invention provides a method of surfacing a well bore, comprising the steps of: placing a surfacing head into a well bore; feeding deposition material down the well bore to the surfacing head; and applying the deposition material to the inner surface of the well bore.

In an embodiment, feeding the deposition material to the surfacing head comprises rotating an Archimedes screw attached to the surfacing head to transfer deposition material to the surfacing head.

In an embodiment, applying the deposition material to the inner surface of the well bore comprises creating an aperture between the surfacing head and the inner surface of the well bore.

In an embodiment, heat is applied to the deposition material.

In an embodiment, a sensor provides information to operators of the surfacing head.

In an embodiment, the inner surface comprises pipe segments placed within the well bore.

In an embodiment, the deposition material is applied directly to the surface of the well bore.

In an embodiment, compressed air is delivered to the surfacing head to generate an empty volume of space in which the deposition material is applied to a target surface.

Many additional features and advantages of the present invention will be realized from the detailed description and the accompanying drawings.

### BRIEF DESCRIPTION OF THE DRAWINGS

FIG. 1 shows an elevation view of the unit of the present invention within a well.

FIG. 2 shows a plan view of the view shown in FIG. 1, as viewed looking down a well.

FIG. 3 shows the extruder portion of the unit feeding material to the head portion of the unit.

FIG. 4 shows the head portion of the unit generating a pipe segment within the well.

FIG. 5 shows a plan view of the head as viewed from the bottom.

### DETAILED DESCRIPTION OF THE INVENTION

The present invention solves the problems described above by providing devices and methods to form pipe from a liquid or plastic deposition process. An extruder that squeezes out plastic (or any other material that can be molded in a solid state) forms a pipe in place, either inside an existing pipe for repair and corrosion prevention purposes or inside an open well for well construction purposes.

Alternatively, similar to 3D printing applications, an applicator nozzle can rotate while spreading warmed up but solid plastic (or any other material that can be molded in a solid state) through the extrusion nozzle or applying liquefied plastic or other material that solidifies upon contact with air, drilling liquid or as it cools.

Thus, pipe can be created or existing pipe plastic-coated through the deployment of a down-well applicator or extruder (referred to herein as the “unit”) that is properly positioned, to repair cracks or other damaged portions of pipe segments from inside the pipe. The unit can be combined with or incorporate the dispenser of an adhesive, such as cement, silicon, etc. to seal and to create or enhance adhesion on the outside of the pipe to the outside pipe, in case of repair or to the well walls, in the case of construction.

The unit can be equipped with mechanisms for expanding the newly created pipe to ensure that the unit can pass through the recently created pipe, sensors for detecting the edge of existing plastic pipe, to enable stopping and starting of pipe production, the proximity to the well walls, to determine the type of approach for adhesion and a cone-shaped tail to allow the equipment to get centered and not get caught on the pipe-lip if it is being pulled back out.

In an embodiment, the unit includes a central portion, surrounded by an outer portion that maintains contact with the central portion, through which forming material is fed to the applicator. Alternatively, material feed tubes, and power and data cables can be connected not in the center, with off-center connection mechanism.

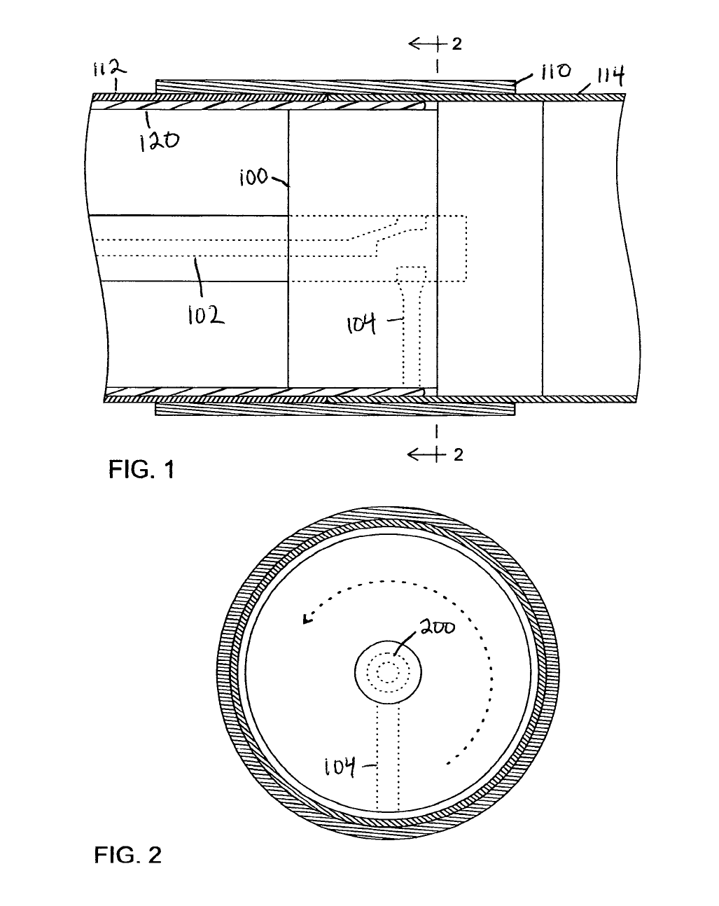

Directing attention to FIG. 1, there is shown generally unit 100, which includes an inlet 102 and an outlet 104 for deposited material that forms a pipe segment or sealing joint between existing pipe segments, depending on usage. Unit 100 can be motorless, and operated from a spinning, hollow shaft in one embodiment, or in an alternative embodiment, can be a motored unit that is provided power from an above-ground power source fed down to the unit. As shown in FIG. 1, inside a well bore 110, often there are segments of pipe 112, 114, which are driven down the well to keep the well bore 110 from collapsing. Unit 100 applies an inner surface 120 as a deposited material. As shown in FIG. 2, unit 100 is shown in a plan view as seen looking down the well bore 110, with the pipe segment 112 as an intermediary surface, and the applied surface 120. As shown, in the center of FIG. 2, concentric rings show extruder 200 and outlet 104, which are portions of unit 100, in dashed lines.

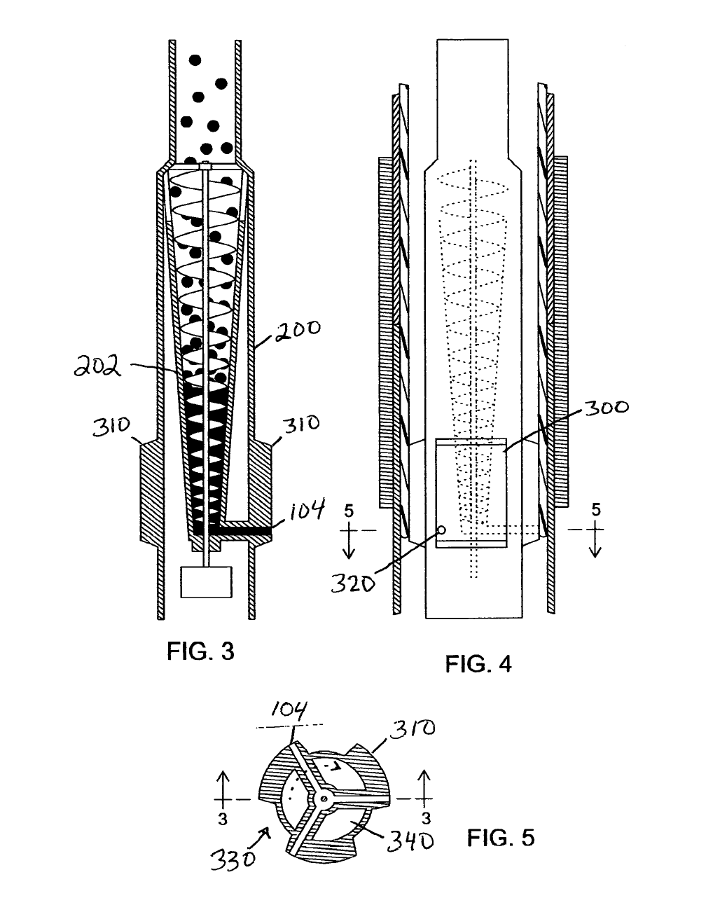

FIG. 3 shows extruder 200 feeding material to the head portion of unit 100. As shown, a rotating Achimedes screw 202 drives the material downward into a taper, thus increasing the pressure of the delivered material through outlet 104 and onto the surface of pipe segments 112, 114, or, alternatively, directly against well bore 110. As shown in FIG. 4, alternatively, screw 202 is contained within head 300. In an embodiment, outlet 102 can incorporate an applicator nozzle, similar to those found in three-dimensional printers. Also shown in FIGS. 3 and 4 are blades 310. Blades 310 are useful to scrape or wipe the surface to which outlet 104 is to apply material, for example in a well filled with liquid, such as oil or water. In such situations, blades 310 provide a clean surface, and can incorporate compressed air or vacuum, depending on embodiment, to provide an empty volume in which outlet 104 can operate to apply material to the target surface. In an embodiment, blades 310 press the deposited material against the target surface, and heat can be applied to the deposited material through blades 310 to cure the deposited material.

In an embodiment, sensor 320 can be included with head 300, and can be either an optical sensor or camera, or a temperature sensor, or a liquid sensor, depending on embodiment. Sensor 320 serves to provide information to operators at surface level, so that decisions can be made regarding operation of head 300. FIG. 5 shows a plan view of head 300 as viewed from below, with three blades 310 defining two sets of apertures within the operational space of head 300. First, apertures 330, located around the circumference of head 300 show the space created by blades 320 between head 300 and the target surface. Second, inner apertures 340 are shown within head 300, in which material can be stored before centrifugal force or air pressure expends the material through outlet 104 to the target surface.

While a system and method have been described and illustrated for depositing material on the inner surface of a well bore, it is to be understood that numerous modifications can be made to the various embodiments described herein without departing from the spirit of the invention.

What is claimed is:

1. A well surfacing device, comprising:
a surfacing head, including an inlet for deposition material disposed in a substantially vertical orientation and an outlet for deposition material disposed in a substantially horizontal orientation to a target surface; and
a material feeding portion connected to the surfacing head, the material feeding portion delivering deposition material from above the head in a substantially vertical orientation downward to the surfacing head.

2. The well surfacing device of claim 1, wherein the material feeding portion comprises an Archimedes screw.

3. The well surfacing device of claim 1, wherein the outlet for deposition material comprises at least one applicator nozzle.

4. The well surfacing device of claim 1, wherein the surfacing head comprises a plurality of blades.

5. The well surfacing device of claim 4, wherein blades in the plurality define apertures in which the deposited material is applied to a target surface.

6. The well surfacing device of claim 1, further comprising a sensor located on the surfacing head.

7. The well surfacing device of claim 1, wherein the surfacing head comprises a vacuum.

8. The well surfacing device of claim 1, wherein the surfacing head includes compressed air delivered from above ground.

9. The well surfacing device of claim 1, wherein the target surface comprises segments of pipe.

10. The well surfacing device of claim 1, wherein the target surface comprises a well bore.

11. A method of surfacing a well bore, comprising the steps of:
placing a surfacing head into a well bore;
feeding deposition material down the well bore to the surfacing head; and
applying the deposition material to the inner surface of the well bore.

12. The method of claim 1, wherein feeding the deposition material to the surfacing head comprises rotating an Archimedes screw attached to the surfacing head to transfer deposition material to the surfacing head.

13. The method of claim 11, wherein applying the deposition material to the inner surface of the well bore comprises creating an aperture between the surfacing head and the inner surface of the well bore.

14. The method of claim 11, wherein heat is applied to the deposition material.

15. The method of claim 11, wherein a sensor provides information to operators of the surfacing head.

16. The method of claim 11, wherein the inner surface comprises pipe segments placed within the well bore.

17. The method of claim 11, wherein the deposition material is applied directly to the surface of the well bore.

18. The method of claim 11, wherein compressed air is delivered to the surfacing head to generate an empty volume of space in which the deposition material is applied to a target surface.
